(19) United States
(12) Patent Application Publication
(10) Pub. No.: US 2017/0271742 A1
(43) Pub. Date: Sep. 21, 2017

(54) DIRECTIONAL COUPLER AND POWER SPLITTER MADE THEREFROM

(71) Applicant: AKG Acoustics GmbH, Wien (AT)

(72) Inventor: Nikola DOBRIC, Wien (AT)

(73) Assignee: AKG Acoustics GmbH, Wien (AT)

(21) Appl. No.: 15/462,218

(22) Filed: Mar. 17, 2017

(30) Foreign Application Priority Data
Mar. 17, 2016 (EP) 16160886.4

(51) Int. Cl. H01P 5/18

(52) U.S. Cl. CPC H01P 5/184

(57) ABSTRACT

A directional coupler including at least two coupled lines and at least three ports is disclosed. A first coupled line of the at least two coupled lines includes at least two ports such as an input port and an output port. A second coupled line of the at least two coupled lines includes a forward path and a backward path that are joined together at a third port to form a loop. To achieve a constant coupling attenuation over a broad frequency band and to minimize dimensions, the second coupled line includes a higher line impedance than the first coupled line, at least two times higher, and a coupling resistor is connected in series either in the forward path or in the backward path. In a multichannel power splitter, directional couplers are arranged in series with one another.

### CROSS-REFERENCE TO RELATED APPLICATIONS

This application claims foreign priority benefits under 35 U.S.C. §119(a)-(d) to EP Application 16160886.4 filed Mar. 17, 2016, which is hereby incorporated by reference in its entirety.

### TECHNICAL FIELD

The invention relates to a directional coupler and a power splitter made therefrom. The directional coupler includes at least two coupled lines and at least three ports. The first coupled line includes at least two ports, an input port and an output port. A second coupled line includes a forward path and a backward path that joined together at a third port, the coupled port. The second coupled line forming a loop.

### BACKGROUND

A directional coupler with the above mentioned features is disclosed in WO 2009/000 434 (PCT/EP2008/004 791) and comprises an inductor connected in series to the backward path. The purpose of this coupler is to provide a good sharpness of directivity within the desired frequency range with low cost for the construction of the circuit.

Directional couplers and power splitters are used in the radio frequency (RF) technique and serve to couple electromagnetic power into or out of a circuit, e.g., to split up an antenna signal into different frequency ranges like high frequency (HF), ultra-high frequency (UHF), and very high frequency (VHF). Nowadays they are mostly realized in planar technology with striplines or microstrips on a dielectric substrate, a further example of which is given by U.S. Pat. No. 5,424,694.

Directional couplers for a broad frequency band are so far mostly designed as line couplers (tapered line couplers, branch line couplers etc) where the second coupled line is usually grounded on one end by a resistor and leading with its other end to the coupled port. Both coupled lines have usually the same line impedance. Broadband directional couplers of this construction type are more or less huge which is a major disadvantage in the timing nano-world.

### SUMMARY

It is an object of the invention to provide a broadband directional coupler, e.g., for a frequency range from 470 to 950 MHz, having minimized dimensions.

According to the invention, this object is achieved with a directional coupler mentioned above at the beginning, characterized in that the second coupled line has a higher line impedance than the first coupled line, at least two times higher, and in that a resistor is connected in series either in the forward path or in the backward path.

The invented directional coupler differs from that one disclosed in WO 2009/000 434 (PCT/EP2008/004 791) by different line impedances of the two coupled lines, the second coupled line having a higher line impedance to tap the electromagnetic field, at least two times higher, and use a lossy resistance matching to transform it to the output impedance. By these measures, a directional coupler with a constant coupling attenuation over a broad frequency band (e.g., 470 to 950 MHz) is achieved with the least effort and space required on the substrate. In contrast thereto, the prior art mentioned uses a 1:1 transformation and is based on using interferences by using a coupling inductance to improve the sharpness of directivity.

An advantageous embodiment of the directional coupler according to the invention is characterized in that a grounded inductance and a capacitance forming an LC-element, are connected to the loop between the coupling resistor and the third port. A grounded resistor is connected to the loop on the opposite side of the coupling resistor. Such an embodiment enhances the flexibility and tunability of the frequency response of the directional coupler, i.e., by adjusting the value of these components the transmission characteristics may be better adapted.

It is a further object of the invention to create a power splitter comprising directional couplers according to the invention and having, in comparison with the state of art, higher decoupling attenuations and lower energy losses.

This object is achieved in accordance with the invention by a power splitter in which the directional couplers according to the invention are connected in series, each having a customized coupling attenuation.

Due to the galvanic (ohmic) isolation of the outputs of the directional couplers, high decoupling attenuations are achieved which cannot be realized with conventional power splitters (like Wilkinson dividers) in tree structure arrangements. Moreover, the coupling attenuation can be exactly adjusted by the distance of the first coupling line, the main line, to the other (second) coupling lines in order to extract only a small amount of the input energy.

As the energy loss at the output of the main line of the power splitter according to the invention is less than that of conventional power splitters, it is based on a given input energy, with which it is possible to connect to further devices, (e.g., receivers, splitters etc.). To this aim, it is recommended in accordance with the invention to connect to the output of the power splitter a slope compensator and an attenuator in series, whereby the attenuator is by-passed by a lossless path by means of RF-switches placed on both of its sides.

The slope compensator serves for equalizing the frequency response caused by the series of directional couplers. It is an attenuator having a decreased attenuation at an increase of frequency in order to adapt the level relations. By way of the two RF-switches, the output signal of the power splitter can be switched between a path with the (linear) attenuator or a lossless pass, in order to use the output as one additional receiver channel or to use it as a high power output to be connected e.g., to a passive Wilkinson divider providing, for example, at least eight further receivers with a signal.

A more advantageous embodiment of the power splitter is characterized in following the series of directional couplers an additional directional coupler, a first RF-switch, a slope compensator and a second RF-switch are connected in series. In this case, the first coupled line of the additional direct coupler is connectable to a grounded resistor by way of the first RF-switch and the second coupled line of the additional directional coupler leads to a by-pass connected to the second RF-switch.

In this arrangement, the output of the additional directional coupler can be switched between two alternatives depending on the desired function. In the first alternative, the output of the first coupled line of the additional directional coupler, which is the main line, is connected to the grounded resistor, acting as wave absorber, and the output of the second coupled line is connected to the final output. In this case, detrimental reflexions in the main line are eliminated. In the second alternative, the main line is connected to the slope compensator which is switched to the final output. Thus, the output turns into a high power output which e.g., may operate a Wilkinson divider distributing the signal to at least eight further receivers.

The invention is explained in more detail on basis of several examples shown in the drawings:

### BRIEF DESCRIPTION OF THE DRAWINGS

FIGS. 1 to 3 show in principle different embodiments of directional couplers according to the invention.

FIG. 4 is a diagram illustrating the technical progress of the invention over the state of art.

FIG. 5 shows another advantageous embodiment of the invention.

FIG. 6 is a diagramm of the frequency response of the circuit according to FIG. 5.

FIGS. 7 and 8 illustrate two inventive embodiments of a power splitter comprising directional couplers according to the invention.

### DETAILED DESCRIPTION

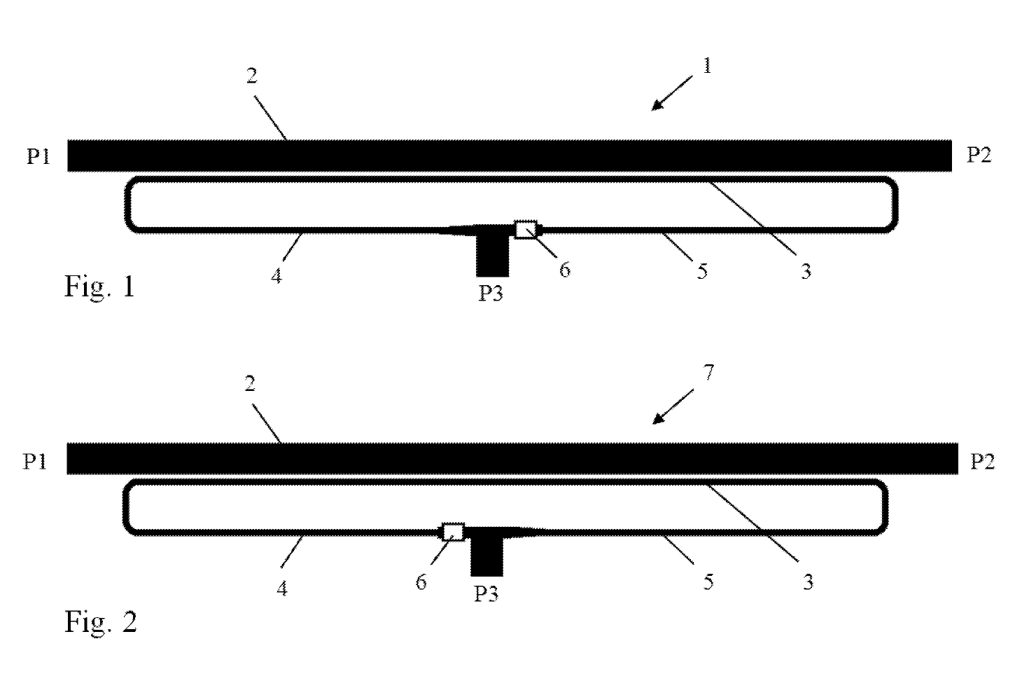

FIG. 1 shows in principle an inventive directional coupler 1 in stripline technology. It consists of a first coupled line 2 the main line, having an input port P1 and a transmitted port P2, and a second coupled line 3 forming a loop and having a forward path 4 and a backward path 5 connected to a coupled port P3. In the backward path 5, is a coupling resistor 6, connected in series. A radio frequency signal is transmitted from the first coupled line 2 to the second coupled line 3. The second coupled line 3 has a higher impedance resulting in a thinner conductor track width than that of the first coupled line 2. To achieve broadband coupling, a line impedance of the second coupled line 3 is chosen at least two times higher than a line impedance of the first coupled line 2.

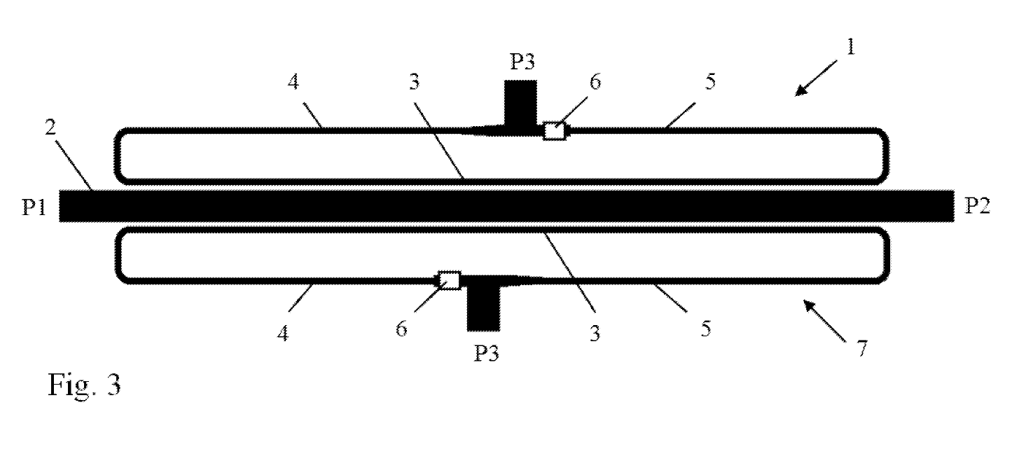

FIG. 2 shows an analogous directional coupler 7 in which the coupling resistor 6 is placed, in the forward path 4 for coupling-in of a signal from the second line 3 into the first line 2. FIG. 3 shows a combination of the examples of FIGS. 1 and 2.

The loop of the second coupled line 3 can be modified with respect to length, width, track width, distance of a coupling structure to set the desired frequency and a frequency response compensation. A position of the coupled port P3 of the forward path 4 and backward path 5 can be used as well to set the frequency response compensation. In other words, the wave impedance of the second coupled line 3, the length of the forward path 4, the length of backward path 5 and the resistor 6 which can be placed in the forward path 4 or the backward path 5 determine the transmission properties, especially the bandwidth of the coupler 1. The desired frequency range and frequency response can be tuned by determining these parameters. A coupling attenuation is adjusted only by the distance between the two coupling lines 2, 3.

Typical values for UHF application (470-950 MHz):

coupling resistor 220Ω

loop length 65 mm

loop width 5 mm

track width main line 2 mm

track width loop line 0,5 mm

coupling distance 0,5 mm

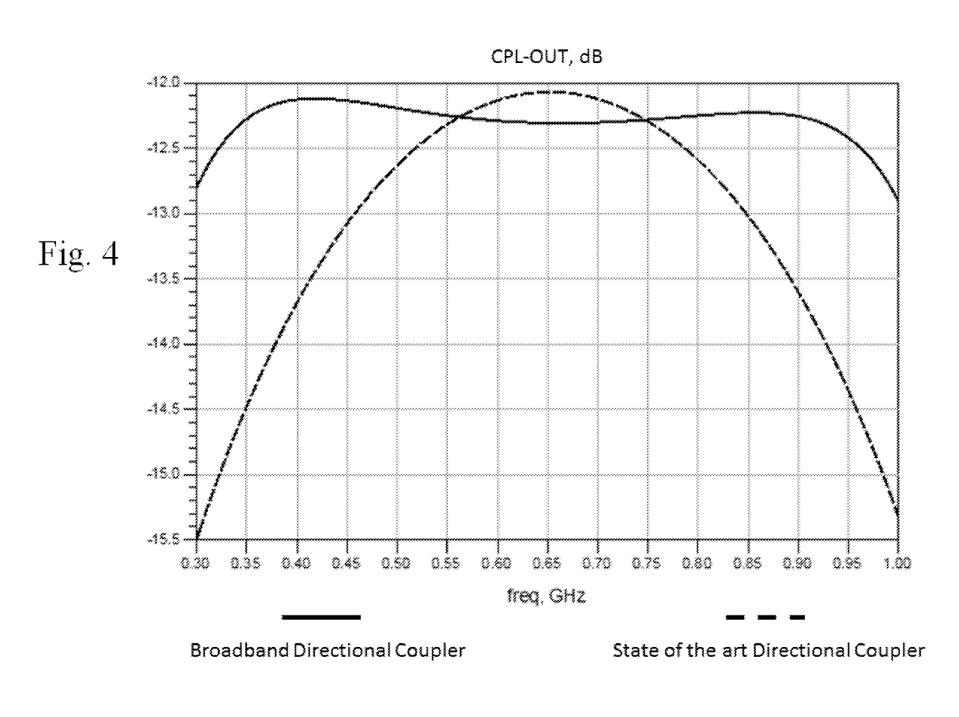

With parameters like these, a high coupling factor, almost constant over a wide frequency range, can be achieved as shown in FIG. 4. For comparison reasons, the frequency response of a conventional directional coupler is shown in broken lines which has an optimum between 0.60 and 0.70 GHz. In contrast thereto, the directional coupler of the invention has a more or less constant coupling factor nearly at the same level between about 0.35 to 0.95 GHz. In contrast to the state of art, the directional coupler according to the invention is a real broadband directional coupler.

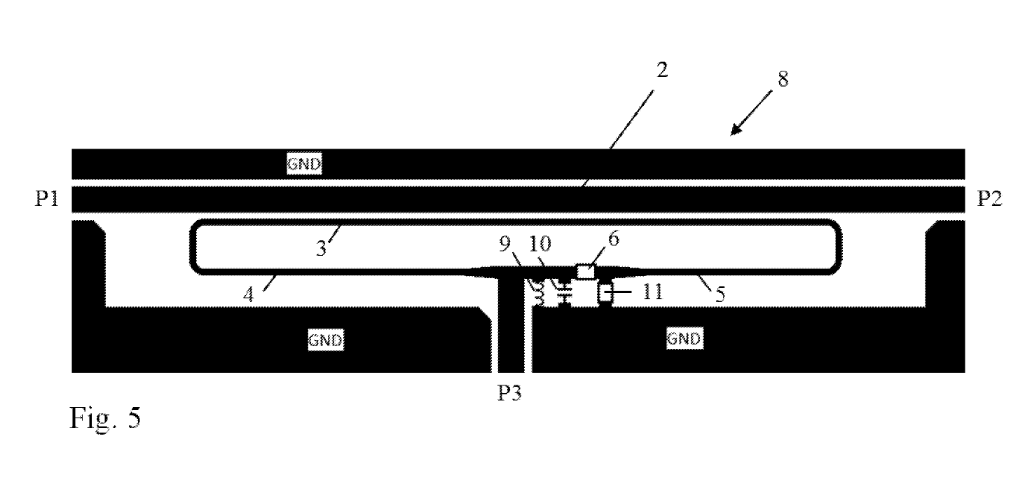

FIG. 5 shows an embodiment of the directional coupler 8 according to the invention in which a grounded inductance 9 and a capacitance 10, forming a LC-element, are connected to the loop between the coupling resistor 6 and the third port P3 and a grounded resistor 11 is connected to the loop on the opposite side of the coupling resistor 6. The transmission characteristics can advantageously be adjusted by the value of these components which allows even greater flexibility of tunability of the frequency response.

Typical value for this embodiment are:

substrate . . . FR 4, 1.6 mm thick

coupling resistor 6 . . . 220Ω

inductance 9 . . . 20 nH

capacitance 10 . . . 1.2 pF

grounded resistor 11 . . . 330Ω

loop length . . . 53 mm

loop width . . . 4.5 mm

coupling distance . . . 0.5 mm

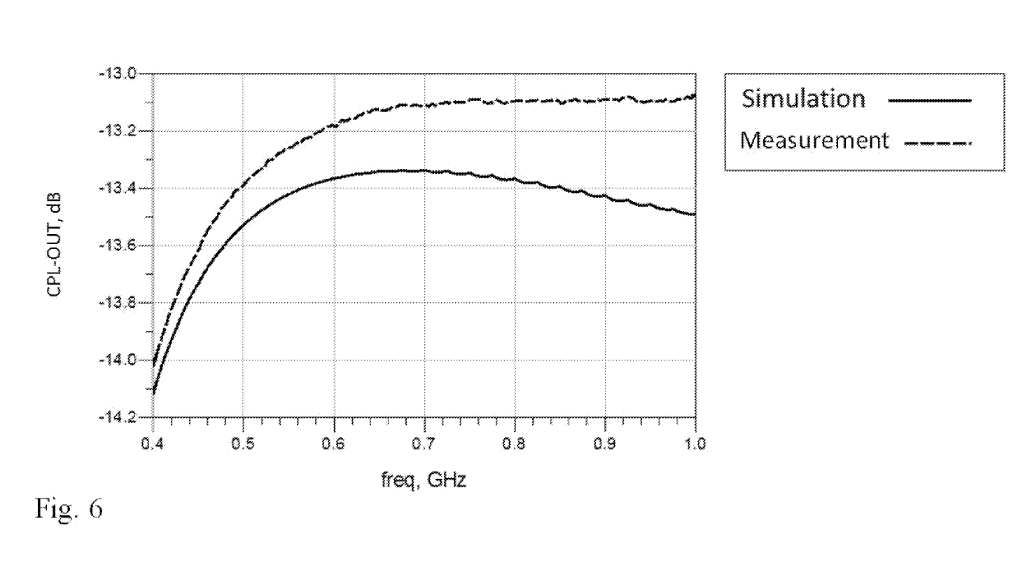

The frequency response achieved with these parameters is shown in FIG. 6. As can be gathered from the broken line, the coupling factor is almost constant in the wide range from 0.6 to 1.0 GHz. The mentioned parameters lead to active coupling structure dimensions of 55×12 mm or total external dimensions of 84×38 mm. Thus, the present broadband directional coupler 8 is just half as large as a conventional directional coupler whose length would have to be at least 110 mm at the same mean frequency of about 700 MHz.

To sum up, the directional coupler of the present invention has a nearly constant coupling factor over a wider frequency range than the state of art. Moreover, the directional coupler can be produced much smaller than comparable conventional directional couplers.

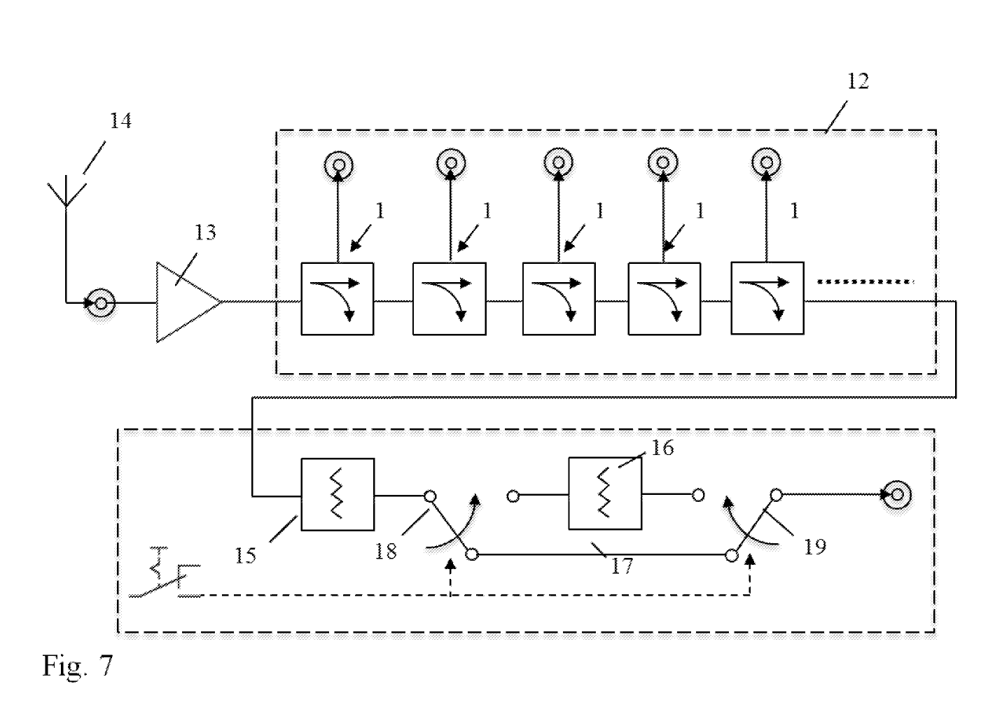

Due to the extraordinary properties of the directional coupler according to the invention several such couplers that each have a customized coupling attenuation, can be connected in series to form a broadband power splitter 12 as shown in FIG. 7. The number of series elements depends on the power input, i.e., as shown in FIG. 7, on the gain of a (low noise) amplifier 13 receiving the broadband signal from an antenna 14. As already mentioned before, the galvanic isolation of the outputs of the directional couplers result in high decoupling attenuations which cannot be realized with conventional power splitter technologies such as the Wilkinson divider. Moreover, the coupling attenuation can be exactly adjusted by the distance of the first coupling line and the main line, to the other coupling lines to extract only as much energy as necessary. The power with which the low noise amplifier provides is optimally utilized which minimizes losses.

The energy saved at the final output of the main line of power splitter 12, in comparison to the output of conventional power splitters with, for example, a tree structure, can, according to the invention, be used to provide additional receivers. As shown in FIG. 7, a slope compensator 15 and an attenuator 16 are connected in series, whereby the attenuator 16 is by-passed by a lossless path 17 by means of RF-switches 18, 19 placed on both of its sides. The slope compensator 15 serves to equalize the frequency response caused by the directional couplers 1. When the radio frequency-switch 18 connects the slope compensator 15 to the attenuator 16, and the RF-switch 19 connects the attenuator 16 to the output, then the output is used as one additional receiver channel. When, on the other hand, the RF-switches 18, 19 take the position as shown in FIG. 7, then the slope compensator 15 is directly connected to the output via the lossless path 17 so that the output is used as high power output to which e.g., a passive Wilkinson divider providing at least eight further receivers with a signal may be connected.

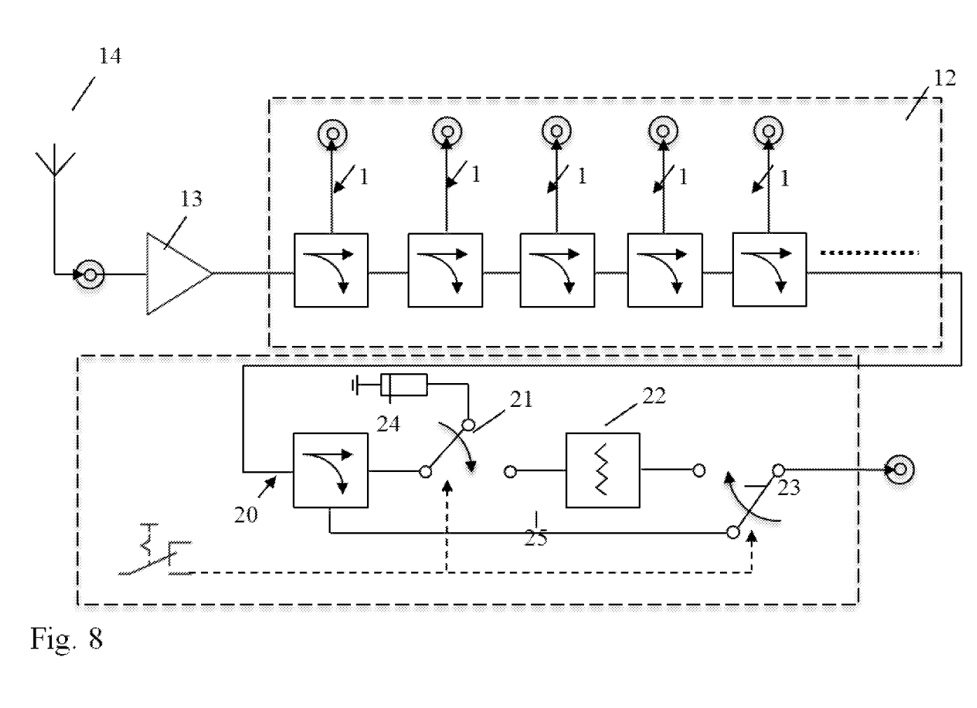

FIG. 8 shows a more advantageous arrangement in which the power splitter 12 includes directional couplers 1 that are followed in series by an additional directional coupler 20, a first RF-switch 21, a slope compensator 22 and a second RF-switch 23. The first coupled line of the additional directional coupler 20 is connectable to a grounded resistor 24. The ground resistor may be a 50 Ohm resistor, e.g., 50Ω. The second coupled line of the additional directional coupler 20 leads to a by-pass 25 of slope compensator 22 that is connected to the second RF-switch 23. In the position of the RF-switches 21 and 23, as shown in FIG. 8, the output of the first coupled line of the additional directional coupler 20 (the main line) is connected to the grounded resistor 24 that acts as wave absorber and the output of its second coupled line is switched to the final output. Thus, unwanted reflections in the main line are eliminated. In the other position of the RF-switches 21, 23; the main line of the additional directional coupler 20 is connected to the slope compensator 22 which is switched to the final output. In this constellation, the output is used as a high-power output to operate, for example, a Wilkinson divider which in turn may distribute the signal to at least eight further receivers.

To sum up, the power splitter according to the invention saves energy, in comparison with conventional power splitters, which can be used to provide additional receivers including additional splitters such as a passive Wilkinson divider.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A directional coupler comprising:
at least two coupled lines including a first coupled line and a second coupled line; and
at least three ports including an input port, an output port, and a coupled port,
wherein the first coupled line includes the input port and the output port,
wherein the second coupled line includes a forward path and a backward path that is joined together at the coupled port to form a loop, and
wherein in the second coupled line, a coupling resistor is connected in series in one of the forward path or the backward path.

2. The directional coupler of claim 1, further comprising a grounded inductance and a capacitance to form an LC-element, the grounded inductance and capacitance being connected to the loop between the coupling resistor and the coupled port.

3. The directional coupler of claim 2 further comprising a grounded resistor that is connected to the loop on a side of the coupling resistor.

4. A power splitter comprising at least two directional couplers including a first directional coupler and a second directional coupler, each of the first directional coupler and the second directional coupler including the directional coupler of claim 1.

5. The power splitter of claim 4, wherein the first directional coupler and the second directional coupler are connected in series and wherein each of the first directional coupler and the second directional coupler include a customized coupling attenuation.

6. The power splitter of claim 5, further comprising a slope compensator and an attenuator being connected in series about an output of the power splitter.

7. The power splitter of claim 6, wherein the attenuator is by-passed by a lossless path via radio frequency (RF) switches placed on both a first side and a second side of the attenuator.

8. The power splitter of claim 4 further comprising an additional directional coupler, a first radio frequency (RF) switch, a slope compensator, and a second RF switch that are connected in series with one another.

9. The power splitter of claim 8 wherein the first coupled line of the additional direct coupler is connectable to a grounded resistor via the first RF switch and the second coupled line of the additional directional coupler leads to a by-pass that is connected to the second RF switch.

10. A directional coupler comprising:
a first coupled line;
a second coupled line; and
at least three ports including an input port, an output port, and a coupled port,
wherein the first coupled line includes the input port and the output port,
wherein the second coupled line includes a forward path and a backward path that is joined together at the coupled port to form a loop, and
wherein in the second coupled line, a coupling resistor is connected in series in one of the forward path or the backward path.

11. The directional coupler of claim 10 further comprising a grounded inductance and a capacitance to form an LC-element, the grounded inductance and capacitance being connected to the loop between the coupling resistor and the coupled port.

12. The directional coupler of claim 11 further comprising a grounded resistor that is connected to the loop on a side of the coupling resistor.

13. A power splitter comprising:
a first directional coupler; and
a second directional coupler, wherein each of the first directional coupler and the second directional coupler include:
a first coupled line;
a second coupled line; and
at least three ports including a first input port, a first output port, and a first coupled port,
wherein the first coupled line includes the first input port and the first output port, and
wherein the second coupled line includes a first forward path and a first backward path that is joined together at the first coupled port to form a loop.

14. The power splitter of claim 13, wherein each of the first directional coupler and the second directional coupler include a grounded inductance and a capacitance to form an LC-element, the grounded inductance and the capacitance being connected to the loop between a coupling resistor and the first coupled port.

15. The power splitter of claim 14, wherein each of the first directional coupler and the second directional coupler further include a grounded resistor that is connected to the loop on a side of the coupling resistor.

16. The power splitter of claim 13 wherein the first directional coupler and the second directional coupler are connected in series and wherein each of the first directional coupler and the second directional coupler include a customized coupling attenuation.

17. The power splitter of claim 13, further comprising a slope compensator and an attenuator being connected in series about an output of the power splitter.

18. The power splitter of claim 17, wherein the attenuator is by-passed by a lossless path via radio frequency (RF) switches placed on both a first side and a second side of the attenuator.

19. The power splitter of claim 13 further comprising an additional directional coupler, a first radio frequency (RF) switch, a slope compensator, and a second RF switch that are connected in series with one another.

20. The power splitter of claim 19 wherein the first coupled line of the additional direct coupler is connectable to a grounded resistor via the first RF-switch and the second coupled line of the additional directional coupler leads to a by-pass that is connected to the second RF switch.
